(19) United States
(12) Patent Application Publication
(10) Pub. No.: US 2025/0146911 A1
(43) Pub. Date: May 8, 2025

(54) DEVICE FOR SAMPLING SOLID PARTICLES COMPRISING AT LEAST ONE CAPACITIVE VALVE

(71) Applicant: AXENS, Rueil-Malmaison (FR)

(72) Inventors: Rémi GIROD, Rueil-Malmaison (FR); Philippe PIERRE, Rueil-Malmaison (FR)

(73) Assignee: AXENS, Rueil-Malmaison (FR)

(21) Appl. No.: 18/867,294

(22) PCT Filed: May 9, 2023
(86) PCT No.: PCT/EP2023/062230

§ 371 Date: Nov. 19, 2024

(30) Foreign Application Priority Data
May 20, 2022 (FR) FR2204836

(51) Int. Cl. G01N 1/20; G01N 1/10

(52) U.S. Cl. CPC G01N 1/2035; G01N 2001/1037; G01N 2001/105; G01N 2001/2057

(57) ABSTRACT

The present invention relates to a device (10) for sampling solid particles from a sealed enclosure (12), sampling device (10) comprising a tubular body (18) carrying a sampling head (16), sampling head (16) being configured for gravity sampling of a volume of solid particles (14) from the enclosure, the device comprising a tubular pipe (52) attached to tubular body (18) and forming a non-zero angle with tubular body (18), tubular body (18) comprising a deflector (50) for deflecting solid particles (14) in tubular pipe (52). Additionally, sampling device (10) comprises a capacitive valve for discharge of the solid particles positioned downstream from tubular pipe (52).

The invention also relates to a method for sampling solid particles, and a method for revamping a sampling device (10).

### FIELD OF THE INVENTION

The present invention relates to the field of solid particle sampling from a sealed enclosure, such as a silo, a hopper, a reactor, a regenerator or an adsorber.

It more particularly relates to a sampling device allowing gravity sampling of solid particles in form of granules, extrudates, balls, like those used for a catalyst or an adsorbent for example.

When solids divided into particles are fed into enclosures operating under pressure and/or at high temperatures, or when they are arranged in enclosures where they are stored or transported by gravity, it is often necessary to take a sample of the solid.

The main purpose of this sampling is to check the mechanical or physico-chemical properties of the solid particles, and thus to detect possible impurities settled at the surface thereof or to monitor the evolution of the quality of the solid stored or in motion.

It notably allows to understand the reasons for a possible malfunction, to check the solid particle storage behavior over time or to predict the maximum operation time for the solid particles and thus to fix or to anticipate possible problems.

In the case of refinery plants using solid particles, it may also facilitate monitoring of the unit comprising for example a catalytic reactor, and thus enable operation thereof to be optimized.

### BACKGROUND OF THE INVENTION

For sampling solids from an enclosure, document U.S. Pat. No. 4,009,618 notably discloses a sampling device allowing to take samples of solid materials from a sealed enclosure, such as a reactor allowing catalytic cracking of hydrocarbons in the presence of a catalyst.

As described in greater detail in this document, sampling is performed using a sampling head fed into the enclosure and carried by the body of the device. This sampling head comprises a receptacle provided with a recess in the upper part and with a recess in the lower part, and two slotted rotating discs rotationally driven by a shaft controlled by any known means. During a first rotation of these discs, a solid sample is allowed into the receptacle through the upper recess controlled by one of the discs while the other disc seals the recess in the lower part. After another rotation of these discs, the upper recess is sealed by one of the discs while the other disc clears the recess in the lower part so that the solid sample is sent to pipes.

Patent application FR-3,007,137 (U.S. Pat. No. 9,464,966) also concerns a solid particle sampling device. In this patent application, the solid particles taken through the sampling head are fed, via pipes, to the inlet of a first valve. Opening of the first valve allows the solid particles to be fed into an airlock. A bleed valve connected to the airlock allows the airlock to be purged. The first valve therefore remains closed and the bleed valve is opened, then closed once purging is completed. Finally, another valve connected to the airlock allows the solid particles contained in the airlock to be discharged.

The valves used are typically conical ball valves, spherical ball valves or parallel slide gate valves with substituting rings.

The sampling devices using these valves however involve several drawbacks.

The valves wear out prematurely. Indeed, the solid particles, once taken from the enclosure, are stored in the body of the device and then, under the effect of gravity, at the valves inlet upstream and downstream from the airlock, in the direction of flow of the solid particles, prior to being recovered in a vessel outside. The solid particles taken from the enclosure are generally at high temperature (between 150° and 550° C. for example according to applications). They are therefore stored at the valves inlet at high temperature.

During progressive opening of the valves, the solid particles at high temperature rub against the surface of the ball of the valve that moves for opening, before the solid particles can flow under gravity through the open valve into the airlock or an outside vessel. This friction of the solid particles against the surface of the ball generates erosive wear of the ball and/or of the seat, the ball/seat contact providing valve sealing. This wear requires regular replacement of the ball and/or of the seat, or of the entire valve, which generates additional operating costs.

In addition, this wear may generate leaking of the fluids contained in the enclosure, notably when the fluid is gas, gas tightness being more difficult to provide than liquid tightness. These leaks may also cause depressurization of the enclosure when it is under pressure.

To overcome such wear, known solutions consist in using surface treatments on the ball and/or the seat of the non-capacitive valves used in order to increase the wear resistance of these parts.

Furthermore, the valves used are more sensitive to valve handling or sequencing errors. Indeed, bad sequencing or handling errors may lead to fluid (notably gas) escaping from the enclosure and, when the enclosure is under pressure, this may also cause depressurization thereof.

The present invention aims to overcome the aforementioned drawbacks by means of a solid particle sampling device using at least one capacitive valve.

### SUMMARY OF THE INVENTION

The invention relates to a device for sampling solid particles from a sealed enclosure, the sampling device comprising a tubular body carrying a sampling head, the sampling head being configured for gravity sampling of a predetermined volume of solid particles from said sealed enclosure, the sampling device comprising a tubular pipe attached to the tubular body and forming a non-zero angle with the tubular body, the tubular body comprising a deflector for deflecting the solid particles in the tubular pipe. Additionally, the sampling device comprises a first capacitive valve for discharging the solid particles, the first capacitive valve being positioned downstream from the tubular pipe, in the direction of flow of the solid particles in the sampling device.

Preferably, the volume of the capacity of the first capacitive valve is greater than said predetermined volume, the volume of the capacity of the first capacitive valve is preferably at least 1.05 times, and more preferably at least 1.15 times said predetermined volume.

Advantageously, the first capacitive valve comprises a single seat and a capacitive ball, the single seat being upstream from the capacitive ball.

Alternatively, the first capacitive valve comprises a first seat, a second seat and a capacitive ball, the first seat being upstream from the capacitive ball and the second seat being downstream from the capacitive ball.

Advantageously, the first capacitive valve is selected from among the capacitive spherical valves, capacitive conical ball valves or capacitive cylindrical ball valves.

According to a variant of the invention, the sampling device comprises a second valve downstream from the tubular pipe for discharge of the solid particles, the second valve being upstream or downstream from the first capacitive valve, the first capacitive valve and the second valve being connected to one another directly or by means of an airlock.

According to an implementation of the invention, the sampling device comprises an interlock key system for preventing simultaneous operation of the first capacitive valve and of the second valve.

Preferably, the airlock is connected to a third valve for discharging a fluid, the fluid being contained in the predetermined volume.

Advantageously, the second valve is a second capacitive valve, the first capacitive valve and the second capacitive valve being preferably identical.

The invention also relates to a system including a sealed enclosure comprising solid particles, and a solid particle sampling device as described above, the system being intended for one of the applications as follows: catalyst sampling in a petroleum refining unit, in a gas or biomass treating plant, in a renewable fuel production unit, in a reforming unit, in a Fischer-Tropsch unit or in a unit for dehydrating alcohol to olefin.

The invention further relates to a method for sampling solid particles from a sealed enclosure using a sampling device as described above, wherein at least the following steps are carried out:
taking a predetermined volume comprising solid particles from the sealed enclosure through the sampling head,
sending the predetermined volume taken to the capacity of the first capacitive valve in sampling position,
actuating the first capacitive valve to discharge the predetermined volume comprising the solid particles of the first capacitive valve, and repositioning the first capacitive valve into sampling position once the predetermined volume discharged.

Preferably, for this method, when the first capacitive valve is positioned upstream from the second capacitive valve, and the sampling device comprises an airlock and a third valve as described above, at least the following steps are carried out:
taking a predetermined volume comprising solid particles from the sealed enclosure through the sampling head,
sending the predetermined volume taken to the capacity of the first capacitive valve in sampling position,
actuating the first capacitive valve to discharge the predetermined volume to the airlock or directly to the second capacitive valve in sampling position, and once the predetermined volume discharged, repositioning the first capacitive valve into sampling position,
when the predetermined volume is discharged to the airlock, preferably discharging a fluid contained in the predetermined volume through the third valve that is opened and subsequently closed once the fluid discharged,
actuating the second capacitive valve to discharge the solid particles contained in the predetermined volume into a vessel, and once the solid particles discharged, repositioning the second capacitive valve into sampling position.

The invention further relates to a method for revamping a device for sampling solid particles from a sealed enclosure, the sampling device comprising a tubular body carrying a sampling head, the sampling head being configured for gravity sampling of a predetermined volume of solid particles from said sealed enclosure, the sampling device comprising a tubular pipe attached to the body and forming a non-zero angle with the body, the body comprising a deflector for deflecting the solid particles in the tubular pipe, the sampling device comprising at least one valve downstream from the tubular pipe, the method comprising a step wherein the at least one valve downstream from the tubular pipe is replaced by a capacitive valve so as to obtain a sampling device as described above.

### BRIEF DESCRIPTION OF THE FIGURES

Other features and advantages of the device, the system and the methods according to the invention will be clear from reading the description hereafter of embodiments given by way of non limitative example, with reference to the accompanying figures wherein:

FIG. 1 is a partial cross-sectional view of the sampling device according to an embodiment of the invention,

FIG. 2 is an end view of the sampling device according to the invention, in the direction of arrow A in FIG. 1,

FIG. 3 is a perspective view of a shutter means of the sampling device according to an embodiment of the invention,

FIG. 4 shows a first type of capacitive valve of the sampling device according to the invention,

FIG. 5 shows a second type of capacitive valve of the sampling device according to the invention,

FIG. 6 shows a first embodiment of the valve assembly of the sampling device according to the invention,

FIG. 7 shows a second embodiment of the valve assembly of the sampling device according to the invention,

FIG. 8 shows a third embodiment of the valve assembly of the sampling device according to the invention,

FIG. 9 shows a fourth embodiment of the valve assembly of the sampling device according to the invention, and

FIG. 10 shows a fifth embodiment of the valve assembly of the sampling device according to the invention.

### DETAILED DESCRIPTION OF THE INVENTION

The terms “top”, “bottom”, “upper”, “lower”, “vertical”, “horizontal” refer to the device or the system in operating position, mounted on the sealed enclosure.

The terms “upstream” and “downstream” refer to the direction of flow of the solid particles in the sampling device, in operating position, when the sampling device is mounted on the sealed enclosure.

In the present description, a capacitive valve is a valve comprising a ball, the ball comprising a capacity (a hollow volume, also referred to as cavity) suited to receive an amount corresponding to its volume of a product (solid particles, with or without fluid for example), the ball being suited to move between at least two positions, a first position referred to as “sampling position” where the product can be fed into the capacity, and a second position referred to as “discharge position” where the product can be discharged from the capacity, for example under the effect of gravity.

When the capacitive valve operates under gravity, the sampling position is characterized by the capacity so positioned (on the upper part of the ball in this position) that the product directly gets into the capacity forming a collection vessel, and the discharge position is characterized by the capacity so positioned (on the lower part of the ball in this position) that the product is discharged from the capacity by gravity.

By design, the capacitive valve is thus not in a situation where the product can freely flow from an inlet to an outlet, unlike usual ball valves and notably valves of the prior art. Indeed, for these valves of the prior art (non-capacitive valves) where the ball has no capacity, the product is blocked at the inlet, upstream from the ball. When the valve is opened (the ball is shifted), the inlet is connected to an outlet and the product can freely flow through and out of the valve: in open position, the valve enables through-passage of the product. On the other hand, a capacitive valve has a sampling position where the product flows into the capacity of the ball (in this case, the ball is connected to the product inlet), and a discharge position where the product contained in the capacity of the ball can flow out (in this case, the ball is connected to the product outlet). For this valve type, there is thus no so-called “through-passage” position where the valve inlet and outlet are directly connected. For the same reason, capacitive valves have no so-called “open” or “closed” position. This absence of through-passage (or open) position allows to limit risks of fluid, and notably gas, leakage.

In the rest of the description, a valve referred to as “non-capacitive” is not a capacitive valve in the sense of the above definition: it therefore has no ball comprising a capacity for collecting solid particles, but it has a closed position where the solid particles are blocked upstream and an open through-passage position where the solid particles can flow through the ball from upstream of the valve to downstream.

The invention relates to a device for sampling solid particles from a sealed enclosure. The solid particles can be, for example, catalysts in a reactor or wheat grains in a silo. The solid particles can come in form of granules, extrudates or balls (minerals, sand, cereal grains) or any form enabling gravity flow.

The sealed enclosure can be a silo, a hopper, a reactor such as a fixed-bed or a continuous-bed catalytic reactor, a regenerator or an adsorber. The enclosure can be under pressure or at atmospheric pressure.

The sampling device is intended to be used when the enclosure is in operation or when it is at standstill.

The sampling device comprises a tubular body carrying a sampling head, the sampling head being configured for gravity sampling of a predetermined volume of solid particles from the sealed enclosure. To take a predetermined volume of solid particles by gravity, the tubular body and the head are inclined so that the solid particles fall naturally into the tubular body under the effect of the weight thereof. The inclination of the tubular body depends on the type of solid particles, their shape, density, and possibly on the fluid (gas or liquid) in which they are integrated, and which may or may not facilitate entrainment thereof in the tubular body. Preferably, the tubular body forms an angle ranging between 30° and 90° to the horizontal in order to facilitate gravity motion of the solid particles.

The sampling head is fed into the inner part of the sealed enclosure. The sampling head advantageously operates according to a baffle principle that allows to take a determined amount (predetermined volume) of solid particles and to prevent flow of a larger amount.

The sampling head can advantageously comprise a cylindrical housing, circular for example, of longitudinal axis coincident with that of the body, which is closed in the upper part by a lid and, in the lower part, by a bottom. The lid and the bottom are each provided with at least one recess in form of an angular sector.

The sampling head can advantageously comprise a solid particle collection recess (in the sealed enclosure), a collected solid particle transfer recess and angular-displacement shutter means for the recesses, the shutter means being controlled by control means. The shutter means can notably comprise a cup provided with an axial hollow running right through the cup to enable collection of the solid particles when the axial hollow is opposite the collection recess, or to enable transfer of the solid particles when the axial hollow is opposite the transfer recess. The transfer and collection recesses are angularly offset so that the axial hollow is opposite one or the other collection and transfer recess, and so that no solid particle can be transferred while other particles are collected at the same time. Thus, the angular offset must correspond to at least the maximum width of the recesses. By means of a sufficient angular offset, a determined volume of solid particles can be taken, which facilitates discharge of the solid particles on the one hand and facilitates the analyses to be carried out on the solid particles thus taken on the other hand.

The control means can comprise a rod connected to the shutter means and/or limiting means, such as stops, for limiting the angular displacement of the control means.

The rod can be connected to an operating lever cooperating with the stops.

The rod can comprise a torsion spring means for circumferential bearing of the lever on one of the stops.

The control means can comprise a rod connected to the shutter means and to a geared motor with two directions of rotation fitted with an end position detection device for limiting the no-load angular displacement of the shutter means, or any other mechanical actuator (pneumatic, hydraulic, electric).

Alternatively, the control means can comprise a rod connected to the shutter means and to a cam controlled by a cylinder.

According to another alternative, the control means can comprise a rod connected to the shutter means and carrying a pinion cooperating with a rack carried by a cylinder.

The tubular body can comprise an upper tubular extension suited to partly fit into the enclosure, which supports the sampling head in order to take solid particles from the enclosure.

The tubular body can also comprise a lower tubular extension that contains the various means for controlling the rotation of the elements (notably the cup) allowing the solid particle sample to be taken.

Preferably, the tubular body can be intended to be reversibly mounted on a tubing of the enclosure so as to be readily removed, replaced or inspected.

The tubular body of the sampling device can for example be provided with a fixing flange intended to be assembled on a flange of the enclosure on which it is positioned.

Furthermore, the sampling device comprises a tubular pipe attached to the tubular body, the tubular pipe forming a non-zero angle with the tubular body, the tubular body comprising a deflector for deflecting the solid particles in the tubular pipe. The tubular pipe is advantageously positioned downstream from the tubular body, in the direction of flow of the solid particles, in the sampling device. Thus, the solid particles, under the effect of gravity, flow from the tubular body into the tubular pipe, after being deflected by the deflector. Advantageously, the tubular pipe has an angle ranging between 10° and 90° with respect to the tubular body axis, preferably ranging between 20° and 70°, more preferably between 30° and 60°, and yet more preferably between 40° and 50°.

Preferably, the lower tubular extension can comprise the deflector housed and fastened in this lower tubular extension for driving the sampled solid particles coming from the tubular body towards the tubular pipe.

The deflector can advantageously carry a deflection surface on which the solid particles are deflected, the deflection surface forming an angle ranging between 0° and 60° with respect to the vertical, preferably ranging between 5° and 45°, more preferably between 10° and 30°.

Additionally, the sampling device comprises a first capacitive valve (at least a first capacitive valve and preferably several capacitive valves, notably two capacitive valves) for discharging the solid particles, the first capacitive valve (or the capacitive valves) being positioned downstream from the tubular pipe, in the direction of flow of the solid particles in the sampling device. By “positioned downstream from the tubular pipe” or “downstream from the tubular pipe”, it is meant that the valve considered is connected to the downstream end of the tubular pipe (the end of the tubular pipe that is not attached to the tubular body), directly (in this case, the valve is attached to this downstream end of the tubular pipe) or indirectly, by means of equipment providing junction between the downstream end of the tubular pipe and the valve.

Indeed, when the first capacitive valve is in sampling position, the solid particles taken by the sampling head fall under gravity into the cavity (also referred to as capacity) of the ball of the first capacitive valve. They are not stored upstream from the ball, on the surface of the ball providing sealing of the valve on its seat. When the capacitive valve is then shifted to discharge position, the solid particles are discharged. Given that the solid particles are in the cavity of the ball and not on the sealing surface of the ball, the ball and the seat (providing valve sealing) of the valve are less subject to wear during operation of the ball. Thus, using the capacitive valve allows to limit wear of the ball and of the seat, to limit leak risks, notably when the enclosure is under pressure of a liquid or a gas, and therefore to limit maintenance of this material (replacement of the ball and/or of the entire valve).

In addition, due to the design of the capacitive valve with no through-passage position, using a first capacitive valve on the sampling device allows to prevent leakage into the atmosphere as a result of improper handling of this valve. It thus allows the safety of the sampling device to be improved.

Advantageously, the volume of the capacity of the first capacitive valve (or of the capacitive valves) can be greater than the predetermined volume (taken in the sampling head). Thus, the solid particles sampled can be entirely contained in the capacity, which prevents contact between the solid particles and the sealing surface of the ball and of the seat while handling the valve. Preferably, the volume of the capacity of the first capacitive valve (or of the capacitive valves) is at least 1.05 times and preferably at least 1.15 times the predetermined volume. Thus, the capacity is large enough to contain the total volume of the solid particles sampled and to prevent contact between the solid particles sampled and the sealing surface of the ball and/or the seat (or the seats if the valve has two seats) of the valve. Premature wear of the valve is thus avoided.

According to a first variant of the invention, the first capacitive valve (or the capacitive valves) can comprise a single seat and a capacitive ball, the single seat being upstream from the capacitive ball. Thus, the capacitive ball comprises the capacity allowing collection and discharge of the solid particles. With a single seat upstream from the ball (i.e. positioned on the side where the solid particles flow in from the tubular body, then the tubular pipe), imperviousness of the valve to the gas and/or to the liquids contained in the enclosure is guaranteed, and the pressure of the enclosure is maintained.

According to a second variant of the invention, the first capacitive valve (or the capacitive valves) can comprise a first seat, a second seat and a capacitive ball, the first seat being upstream from the capacitive ball and the second seat being downstream from the capacitive ball. Thus, the capacity of the capacitive ball can contain the solid particles taken from the sampling head. With a double seat, upstream and downstream, sealing of the valve is improved and wear is minimal.

Advantageously, the first capacitive valve (or the capacitive valves) can be selected from among capacitive spherical valves, capacitive conical ball valves, capacitive cylindrical ball valves or any similar capacitive valve. These valve types are reliable and they minimize wear risks.

A capacitive spherical valve is a valve whose ball is spherical and whose spherical ball comprises the capacity. This type of valve enables optimization of the amount of material relative to the pressure and/or temperature constraints.

A capacitive conical ball valve is a valve whose ball is conical and whose conical ball comprises the capacity. This type of valve is easier to manufacture than capacitive spherical valves. It may be necessary to add a lubrication system or a polymer coating.

A capacitive cylindrical ball valve is a valve whose ball is cylindrical and whose cylindrical ball comprises the capacity. It is the easiest capacitive valve to manufacture.

According to a preferred configuration of the invention, the sampling device can comprise (at least) a second valve positioned downstream from the tubular pipe (directly or indirectly connected to the downstream end of the tubular pipe) for discharge of the solid particles from the sampling device, the second valve being upstream or downstream from the first capacitive valve.

By “the second valve being upstream or downstream from the first capacitive valve”, it is meant that the second valve is connected to the upstream end of the first capacitive valve, directly or indirectly (in this case, the second valve is positioned between the downstream end of the tubular pipe and the upstream end of the first capacitive valve), or that the second valve is connected to the downstream end of the first capacitive valve, directly or indirectly.

In other words, in the direction of flow of the solid particles in the sampling device, the solid particles can first flow through the first capacitive valve, then through the second valve, or they can first flow through the second valve, then through the first capacitive valve. It is however more interesting to use the first version (first flow through the first capacitive valve). Indeed, since the capacitive valve allows to prevent wear and to improve sealing, it is advantageous for the upstream valve to be the first capacitive valve, which allows to provide better sealing and to avoid enclosure depressurization risks. In addition, the first valve through which the particles flow is the one undergoing the highest temperatures, which may generate increased wear of the valve.

The first capacitive valve and the second valve can be connected to one another directly or by an airlock. Using an airlock can be interesting if it is desired to depressurize the sample prior to collecting the solid particles in a vessel at ambient pressure, or to discharge a gas or a liquid contained in the sample with the solid particles. Thus, by means of the airlock, it is possible to drain the predetermined volume.

An “airlock” is understood to be a hollow part, preferably tubular, suited to contain all of the predetermined volume of solid particles.

The upstream valve (advantageously the first capacitive valve) can be directly attached to the tubular pipe.

According to an advantageous implementation of the invention, the sampling device can comprise an interlock key system to prevent simultaneous operation of the first capacitive valve and of the second valve. Indeed, if the second valve is a non-capacitive ball valve and if it is in open position (i.e. in a position where the inlet and the outlet are directly connected), and if the enclosure is under pressure, operation of the first capacitive valve can release the fluid trapped under pressure in the volume of the cavity, and thus generate an accident.

According to an advantageous configuration of the invention, the airlock can be connected to a third valve for discharge of a fluid, the fluid being contained in the predetermined volume. Indeed, the enclosure, a reactor for example, can comprise, in addition to the solid particles, a fluid, often a gas such as hydrogen, a hydrocarbon gas and/or nitrogen. Furthermore, this fluid is often maintained at a pressure above atmospheric pressure (for example at least 5 bar, preferably at least 15 bar) and/or at high temperature (at least 40° C.).

Prior to collecting the solid particles, the fluid is preferably depressurized and/or discharged so as to prevent toxic hazard to staff and/or explosion hazard. Using an airlock between the first capacitive valve and the second valve (from upstream to downstream or from downstream to upstream) allows to add a line for depressurization of the fluid and/or discharge of the fluid (to a flare for burning the gas for example, or to a rinsing system using an inert fluid). A third valve can then be set on this line. Opening of the third (non-capacitive) valve allows the fluid to be discharged (and depressurized if necessary); closing of the third valve allows the airlock to be isolated.

Preferably, the second valve can be a second capacitive valve. Thus, the sampling device comprises two capacitive valves, one directly connected (attached) to the tubular pipe and thus providing sealing with the enclosure, and the other connected downstream, directly or indirectly, by means of an airlock. Both capacitive valves are used to discharge the solid particles. Using two successive capacitive valves allows to limit leak risks even more. It also allows to use a line for discharging the fluid contained in the predetermined volume sampled.

The second capacitive valve can advantageously have the same characteristics as the first capacitive valve. In other words:
the volume of the capacity of the second capacitive valve can be greater than the predetermined volume, preferably, the volume of the capacity of the second capacitive valve is at least 1.05 times, more preferably at least 1.15 times the predetermined volume,
the second capacitive valve can comprise a single seat and a capacitive ball, the single seat being upstream from the capacitive ball,
alternatively, the second capacitive valve can comprise a first seat, a second seat and a capacitive ball, the first seat being upstream from the capacitive ball and the second seat being downstream from the capacitive ball,
the second capacitive valve is selected from among capacitive spherical valves, capacitive conical ball valves or capacitive cylindrical ball valves.

The body of the capacitive valve(s), the ball and the seat(s) are made of a material suited for the application, notably for the fluids present, the pressures and the temperatures. Besides, the seat(s) are made of a material of higher elastic strength and/or hardness than the material the ball and the body are made of, so as to limit wear of the seat(s).

Preferably, the ball and the seat(s) can be subjected to a surface treatment in order to increase the frictional and wear resistance thereof.

Preferably, the first capacitive valve and the second capacitive valve can be identical so as to simplify the design, logistics and maintenance thereof, and to prevent risks of mixing up the two valves upon mounting.

The invention also relates to a system comprising a sealed enclosure and a solid particle sampling device as described above, the sealed enclosure comprising solid particles. The system can be intended for one of the following applications: catalyst sampling in a petroleum refining unit, in a gas or biomass treating plant, in a renewable fuel production unit, in a reforming unit, in a Fischer-Tropsch unit or in a unit for dehydrating alcohol to olefin.

Furthermore, the invention also relates to a method for sampling solid particles from a sealed enclosure using a sampling device as described above, wherein at least the following steps are carried out:
taking a predetermined volume comprising solid particles from the sealed enclosure through the sampling head (for example via the cup and the collection and transfer recesses),
sending the predetermined volume taken (comprising the solid particles taken and possibly a fluid, notably gas) to the capacity of the first capacitive valve in sampling position,
actuating the first capacitive valve to discharge the predetermined volume comprising the solid particles of the first capacitive valve, and repositioning the first capacitive valve into sampling position once the predetermined volume discharged.

Advantageously, when the device comprises a second capacitive valve, with the first capacitive valve positioned (preferably attached to the tubular pipe) upstream from the second capacitive valve (in other words, the solid particles taken first flow through the first capacitive valve, then through the second capacitive valve), the device optionally comprising an airlock and a third valve as described above, at least the following steps can be carried out:
taking a predetermined volume comprising solid particles (and possibly a fluid, notably gas) from the sealed enclosure through the sampling head (for example via the cup and the collection and transfer recesses),
sending the predetermined volume taken to the capacity of the first capacitive valve in sampling position,
actuating the first capacitive valve to discharge the predetermined volume to the airlock (when the sampling device comprises an airlock) or directly to the second capacitive valve in sampling position, and once the predetermined volume discharged, repositioning the first capacitive valve into sampling position,
when the predetermined volume is discharged to the airlock, preferably discharging a fluid contained in the predetermined volume through the first valve that is opened and subsequently closed once the fluid discharged, so as to eliminate this fluid and to send it to a flare for example (notably when it is hydrogen) or to depressurize it in order to bring the airlock to ambient pressure prior to recovering the solid particles,
actuating the second capacitive valve to discharge the solid particles contained in the predetermined volume into a vessel, and once the solid particles discharged, repositioning the second capacitive valve into sampling position.

In the method implemented with the sampling device according to the invention, the solid particle sample taken is not stored upstream from the valve(s), which may cause, upon transfer, erosion of the seat and/or of the ball of the valve against which the solid particles rub. The sample is directly stored in the cavity of the ball of the capacitive valve(s), thus preventing friction with the surfaces forming a seal when operating the valve.

The capacitive valve(s) can be operated manually, pneumatically, electrically or automatically.

When the sampling device comprises a first capacitive valve attached to the tubular pipe followed by an airlock, by a non-capacitive second valve at the airlock outlet for discharging the solid particles from the airlock by gravity, and by a non-capacitive third valve for discharging a fluid such as gas, the sequence of use of these valves can be typically as follows:
in standby position and during collection of the sample in the sealed enclosure: the first capacitive valve is in sampling position for collecting the sample in the cavity of the ball of the valve, and the second and third valves are closed. In contrast to the prior art, the sample is not stored in the body of the device upstream from the first capacitive valve,
in a second step, once the sample collected and stored in the cavity of the first capacitive valve, the latter is rotated 180° into discharge position, the cavity turned downwards while the non-capacitive second and third valves remain closed, so that the sample falls under gravity into the airlock upstream from the closed non-capacitive second valve,
the non-capacitive third valve is then opened and subsequently closed for the fluid initially present in the capacity to be brought to atmospheric pressure or to the pressure of the flare system. Other variants are possible with rinsing by an inert fluid and addition of 2 more valves on the fluid circuit,
the sample is then upstream from the non-capacitive second valve at atmospheric pressure,
the non-capacitive second valve is then opened to collect the sample from a collection pot (vessel) by any means,
the second valve is closed and back in standby position: V1 is positioned to be able to collect the sample, the cavity of the shutter part turned upwards in filling position, V2 and V3 are closed.

When the fluid is not under pressure, using the third valve can be avoided.

When the sampling device comprises a first capacitive valve attached to the tubular pipe, followed by an airlock, by a second capacitive valve downstream from the airlock for discharging the solid particles and by a line connected to the airlock for discharging the fluid, the line comprising a non-capacitive third valve, the sequence of use of the valves can be as follows:
in standby position and during collection of the sample in the sealed enclosure: the first capacitive valve is positioned for collecting the sample in the cavity of the ball of the first capacitive valve, the second valve being in sampling position and the third valve being closed,
once the solid particles taken from the enclosure, generally hot, they are stored in the tubular body of the device,
they are subsequently transferred by gravity from the tubular body of the device into the cavity of the first capacitive valve that is rotated 180° to discharge the sample into the airlock,
then, under gravity, the solid is transferred and stored in the cavity of the ball of the second capacitive valve. In contrast to the prior art, the sample is not stored in the airlock upstream from the non-capacitive second valve in closed position. Erosion of this valve was possible while operating the valve,
the first capacitive valve then remains in discharge position, the non-capacitive third valve remains closed and the second capacitive valve remains in sampling position,
the third valve is opened, then closed for the fluid initially present in the capacity to be brought to atmospheric pressure (a purge is thus performed). Other variants are possible with rinsing by an inert fluid and addition of 2 more valves. The first capacitive valve then remains in discharge position and the non-capacitive third valve remains closed,
the sample is in the cavity of the second capacitive valve at atmospheric pressure,
the second capacitive valve is then rotated 180° to collect the sample in a collection pot (vessel) by any means, the first capacitive valve remaining in discharge position and the third valve remaining closed,
the first and second capacitive valves are then rotated 180° to position them in collection position, and the third valve is maintained in closed position.

In this configuration, the airlock is not compulsory because the predetermined volume can directly fall by gravity into the cavity of the second capacitive valve.

Additionally, when the fluid is not under pressure, using the third valve can be avoided.

The invention also relates to a method of revamping a device for sampling solid particles from a sealed enclosure. The sampling device comprises a tubular body carrying a sampling head, the sampling head being configured for gravity sampling of a predetermined volume of solid particles from the sealed enclosure (typically a reforming reactor), the sampling device comprising a tubular pipe attached to the body and forming a non-zero angle with the tubular body, the tubular body comprising a deflector for deflecting the solid particles in the tubular pipe, the sampling device comprising at least one valve downstream from the tubular pipe. The revamping method comprises a step wherein the at least one valve, preferably two valves, downstream from the tubular pipe (directly or indirectly connected to the downstream end of the tubular pipe) is (are) replaced by a capacitive valve so as to obtain a sampling device as described according to the invention.

Preferably, the initial sampling device (before revamping) comprises a first valve attached to the pipe, the first valve being followed by an airlock and a second valve (downstream from the airlock), and the airlock is connected to a fluid discharge line provided with a third valve. The revamping method then consists in replacing the first or the second valve with a first capacitive valve in order to limit wear of the ball and/or of the seat, to avoid too frequent replacement of the balls, the seats or the valves, and to limit fluid leakage risks. Preferably, both the first and the second valve are replaced by capacitive valves so as to limit even further the risk of fluid leakage and of ball and/or seat wear.

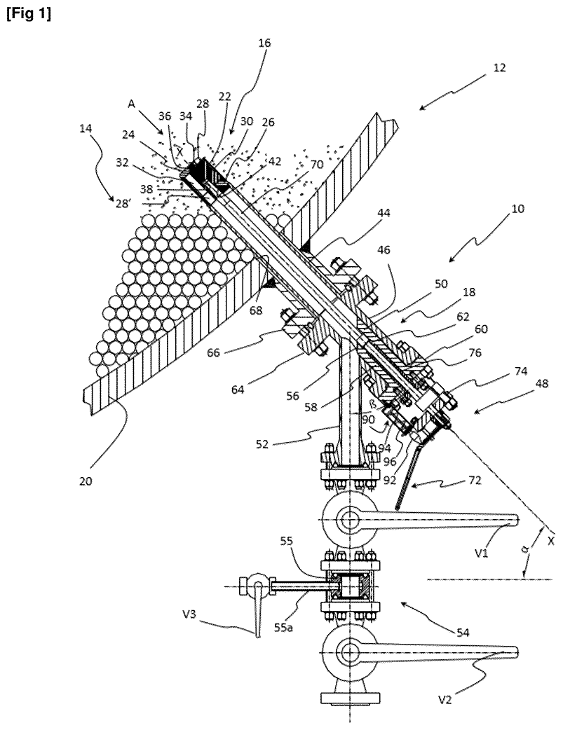

FIG. 1 schematically shows, by way of non-limitative example, a cross-sectional view of a sampling device according to the invention.

The sampling device according to the invention 10 is arranged on an enclosure 12 (notably a reactor), preferably sealed and advantageously isolated from the atmosphere. The enclosure contains solid particles 14 and possibly a fluid (notably gas). The sampling device comprises a sampling head 16 for taking solid particle samples within this enclosure. This sampling head 16 is carried by a tubular body 18 of longitudinal axis XX running through wall 20 of enclosure 12. Sampling head 16 works on the principle of a deflector allowing to take a predetermined volume of solid particles in enclosure 12 and to avoid a flow in larger amount.

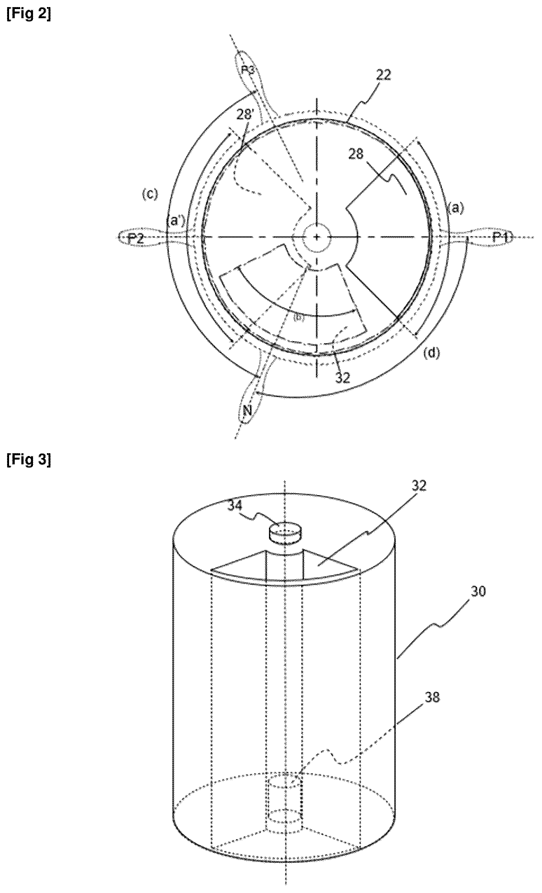

This sampling head 16 comprises a cylindrical housing 22, circular here, of longitudinal axis coincident with that of tubular body 18 while being closed in the upper part thereof by a lid 24 and, in the lower part thereof, by a bottom 26. Lid 24 and bottom 26 are each provided with a recess 28, 28′ in form of angular sectors (whose shape is better visible in FIG. 2). Recess 28 of lid 24 is the collection recess for collecting the solid particles from the enclosure, and recess 28′ of bottom 26 is the transfer recess.

The inside of cylindrical housing 22 contains a shutter means, here in form of a cup 30. The diameter of this cup 30 substantially corresponds to that of the inside of cylindrical housing 22 and the height thereof is substantially equal to that of this cylindrical housing 22, so as to allow this cup 30 to freely rotate inside cylindrical housing 22, and between lid 24 and bottom 26. This cup 30 is provided with a hollow 32 substantially parallel to the longitudinal axis and running right through cup 30 (better visible in FIGS. 2 and 3). Advantageously, hollow 32 has a cross section in form of an angular sector whose shape corresponds to recesses 28 and 28′ of angular sector of lid 24 and bottom 26. Preferably, recess 28 of lid 24 has dimensions and a sector angle smaller than hollow 32 of cup 30, whereas recess 28′ of bottom 26 has dimensions and a sector angle larger than those of hollow 32 of cup 30. The volume of the cup defines the predetermined volume of the sampling head.

Tubular body 18 of the sampling device is advantageously inclined at an angle α of 45° to the horizontal in enclosure 12, so as to facilitate transfer of the solid particles by gravity.

Tubular body 18 comprises an upper tubular extension 44, of circular shape here, which partly penetrates the inside of enclosure 12 and supports sampling head 16 for sampling the solid particles contained in this enclosure 12. Tubular body 18 also comprises a lower tubular extension 46 containing various means 48 for controlling the rotation of cup 30 allowing the sample to be collected.

Lower tubular extension 46 also comprises a deflector 50 housed and fastened within this lower tubular extension 46 for driving the sample taken towards a tubular pipe 52 leading to valve V1, then to an airlock 54.

Deflector 50 has a deflection surface 56 carried by a tubular sleeve 58 with a 25° angle to the vertical, allowing gravity flow of the solid particles sampled towards the airlock. This deflector 50 also comprises a fastening baseplate 60 on the lower end of tubular body 18, as well as a longitudinal axial bore 62 starting from the deflection surface and leading to baseplate 60, allowing passage of the cup rotation control means.

Airlock 54 is connected to three valves V1, V2, V3. A tubular part 55a connects airlock 54 to third valve V3 for discharge of a fluid (which is part of the sample taken with the solid particles, this fluid being also contained in enclosure 12) to a flare or a fluid collection line.

Another tubular part 55 connects airlock 54 to first valve V1 and to second valve V2.

Tubular parts 55 and 55a are substantially orthogonal.

Tubular pipe 52 leading to first valve V1 is provided with a fixing flange 64 for assembly on a sole 66 fastened to the outside of wall 20 and surrounding a pass-through hole 68 for upper tubular extension 44.

Tubular extension 52 is oriented at a non-zero angle β with respect to axis XX of the body.

Rotation control means 48 for cup 30 comprise a driving rod 70 running right through tubular body 18 and deflector 50 by extending from this cup 30 to the outside of the lower end of tubular body 18, where it is connected to an operating lever 72 arranged outside the tubular body.

The upper end of this rod 70 is connected to cup 30 through bore 38 by any known means, such as screwing or male-female jointing, while the lower end of this rod 70 is fixedly connected to operating lever 72, preferably by keying and screwing. Thus, handling operating lever 72 in rotation causes rotational movement of cup 30.

Advantageously, a circular plate 74 is housed between operating lever 72 and the lower end of tubular body 18 by being fastened to the baseplate of deflector 50. Fastening can for example be provided by a system combining pins and nuts, which thus allows to prevent circular plate 74 from being rotated when operating lever 72 is actuated.

Furthermore, a sealing device 76, more commonly referred to as stuffing box, is housed between rod 70 and bore 62. This sealing device 76 thus allows to absorb the temperature and pressure differences between enclosure 12 and the external environment.

Besides, the person skilled in the art is aware of other equipment that may be provided on the system, such as a stuffing box, notably through the information contained in patent application FR-3,007,137 A1.

To form the sampling device, cup 30 is housed in cylindrical housing 22. Bottom 26 is then added to this subassembly by matching bore 38 with perforation 42 in bottom 26. Lid 24 is then added with pin 34 matching blind bore 36. Lid 24 and bottom 26 are attached on cylindrical housing 22 by any known means, such as screwing or welding.

Then, the assembly made up of rod 70, circular plate 74 with stops (not shown), a torsion spring (not shown) and operating lever 72 that controls cup 30 through rod 70 is fed into lower tubular extension 46.

During this introduction, the end of rod 70 is led to rotationally cooperate with bore 38 of cup 30 while being integral with this cup. Once this is completed, circular plate 74 is fastened to deflector 50.

Once this assembly formed, tubular body 18 carrying sampling head 16 is fed into enclosure 12 through pass-through hole 68 and it is fastened onto sole 66 by any known means, such as a screw-bolt connection. Valve V1 is then added and fastened to tubular pipe 52 connected to tubular body 18, then airlock 54 is fastened to the other end of valve V1.

A second valve V2 is fastened downstream from airlock 54 and a third valve V3 is fastened to tubular part 55a of airlock 54.

At least one of valves V1 or V2 is a capacitive valve, preferably at least valve V1. This capacitive valve has (or these capacitive valves have) a capacity located in the ball of the valve suited to receive the predetermined volume of solid particles collected through sampling head 16. Thus, the solid particles are directly stored in the capacity of the valve, without coming into contact with the surface of the ball and that of the seat that provide sealing.

Preferably, both valves V1 and V2 are capacitive valves suited to directly receive the solid particles in the cavity of the ball by gravity.

Valve V3 is intended for discharge of the fluid that is collected with the solid particles in the enclosure. This valve V3 is not a capacitive valve because no erosion is generated by the fluid when operating valve V3.

A pneumatic single-acting cylinder 90 can be used. This pneumatic single-acting cylinder 90 is provided with an ogival-shaped cam 92 integral with piston 94 whose stroke is limited by construction. Return of the cylinder is provided by a spring 96 integrated therein.

Cam 92 is in contact with operating lever 72. When extension from cylinder 90 is required, the pressure in the suitable chamber of this cylinder generates a translational motion of extension of piston 94. This translational motion causes rotation of operating lever 72 by means of cam 92 integral with piston 94.

Since the cylinder is by design provided with stroke-limiting means, the system limits the angular displacement of operating lever 72.

It can be noted that the sampling device can be operated manually at any time and at any operating stage of cylinder 90.

FIGS. 2 and 3 schematically illustrate, by way of non-limitative example, cup 30 and cylindrical housing 22 of the sampling head that works on the principle of a baffle allowing to take a predetermined amount of solid particles and to avoid a flow in larger amount.

This head comprises a cylindrical housing 22, circular here, of longitudinal axis coincident with that of the tubular body while being closed in the upper part thereof by a lid and, in the lower part thereof, by a bottom. The lid and the bottom are each provided with a recess 28, 28′ in form of angular sectors (a) and (a′).

The inside of cylindrical housing 22 contains a cup 30 forming a shutter means, of longitudinal axis coincident with the axis of cylindrical housing 22. The diameter of this cup 30 substantially corresponds to that of the inside of cylindrical housing 22 and the height thereof is substantially equal to that of this cylindrical housing 22, so as to allow this cup to freely rotate inside cylindrical housing 22, and between the lid and the bottom.

This cup 30 is provided with a hollow 32 substantially parallel to the longitudinal axis and running right through cup 30. Advantageously, hollow 32 has a cross section in form of an angular sector (b) whose shape corresponds to the angular sector of the lid and of the bottom.

Recess 28 of angular sector (a) of the lid and recess 28′ of angular sector (a′) of the bottom are offset relative to one another, diametrically offset here, so that there can be no communication by means of hollow 32 of angular sector (b) formed by cup 30, hollow 32 extending axially.

Preferably, recess 28 of the lid is formed on an angular sector (a) whose angle is smaller than the angle of angular sector (b) of hollow 32 of cup 30. Recess 28′ of the bottom is formed on an angular sector (a′) whose angle is larger than the angle of angular sector (b) of hollow 32 of cup 30. The volume of this hollow 32 thus allows to determine the predetermined volume of the solid particles sampled.

This cup 30 is fitted, on the upper plane face thereof, with a locating pin 34 coaxial to the axis of cup 30, which cooperates with a blind bore provided on the inner face of the lid. On the lower plane face thereof, cup 30 comprises a bore 38 intended for connection with the control means (notably a rod).

As better illustrated in particular in FIG. 2, hollow 32 of the cup can have several positions, depending on the position of the operating lever.

More precisely, hollow 32 can have a collection position P1 where this hollow 32 coincides with recess 28. In this collection position P1, a solid particle sample of same volume as the inner volume of hollow 32 of the cup is transferred through gravity from the sealed enclosure to hollow 32 of the cup, then closed in the lower part thereof by the plane face of the bottom.

The discharge position P2, here diametrically opposite collection position P1, corresponds to the position where hollow 32 coincides with recess 28′ of the bottom with transfer by gravity of the solid particle sample from hollow 32 to the tubular body of the sampling device, recess 28 of the lid being then closed by the upper plane face of the cup.

Neutral position N is an intermediate position between collection position P1 and discharge position P2. The neutral position N shown forms an angle (d) with collection position P1. In the neutral position N shown, hollow 32 is not opposite recess 28 of the lid. Therefore, in this neutral position N, it is not possible to take a sample.

FIG. 2 also shows a position of rest P3 where the operating lever rests against a fixed stop (not shown) with a position of hollow 32 of the cup that allows no communication between recesses 28 and 28′.

Thus, during rotation of the lever, and therefore of the cup, between position N and position P3, there is an angular range (c), referred to as no-load displacement, in which no solid sampling occurs.

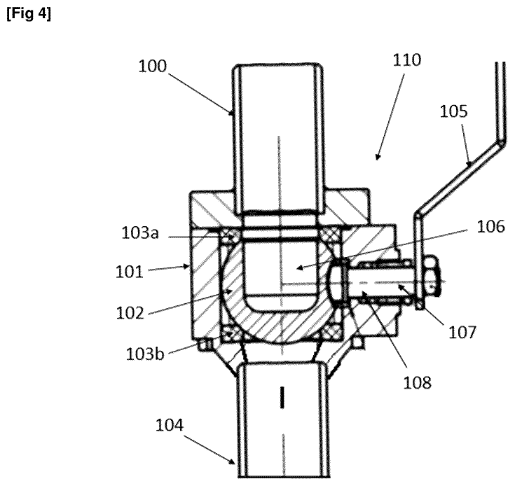

FIG. 4 schematically illustrates, by way of non-limitative example, a first type of capacitive valve 110 for the sampling device according to the invention.

This capacitive valve 110 comprises an inlet pipe 100 and an outlet pipe 104. The inlet and the outlet could of course be reversed but, for operation in gravity mode, with transfer of the solid particles by gravity, the inlet is preferably positioned above the outlet, and inlet pipe 100 and outlet pipe 104, at the connections with capacitive valve 100, are preferably on the vertical axis.

Capacitive valve 110 comprises a box 101 (also referred to as valve body) rigidly attached to inlet pipe 100 and outlet pipe 104.

Box 101 contains a ball 102 (a spherical ball here, the capacitive valve 110 shown is thus a capacitive spherical ball valve) movable (rotationally here) in box 101. Rotation of ball 102 enables operation of capacitive valve 110. This rotation is generated by operating handle 105. A shaft 108 therefore serves as a mechanical link between handle 105 and ball 102 by being rigidly attached to handle 105 and ball 102.

Preferably, shaft 108 is in pivot connection around axis 107 passing through the centre of spherical ball 102. When handle 105 is actuated, shaft 108 rotates around axis 107 and rotationally drives the ball around axis 107.

Ball 102 comprises a capacity 106 consisting of a hollow cavity (a bore here) within ball 102.

Sealing of capacitive valve 110 is provided upstream from the valve (at the inlet) as well as downstream from the valve (at the outlet) through contact between ball 102 and first seat 103a positioned upstream from capacitive valve 110 (therefore above the ball), and between ball 102 and second seat 103b positioned downstream from capacitive valve 110 (therefore below the ball).

In the position illustrated in the figure, capacitive valve 110 is in sampling position, i.e. capacity 106 of the ball is opposite the inlet so as to enable collection of the solid particles taken through the sampling head of the sampling device, under the effect of gravity. In other words, in sampling position, capacity 106 is positioned on the upper part of ball 102 so as to collect the solid particles.

On the other hand, in discharge position, ball 102 has rotated 180° around axis 107, capacity 106 is then in the lower part of ball 102 to discharge the solid particles under the effect of gravity. Capacity 106 is then opposite the outlet of capacitive valve 110.

This type of capacitive valve 110 with two seats upstream and downstream provides increased sealing. Furthermore, this configuration allows to have an offset shaft 108 (on one side of ball 102 only) and not a through shaft.

Of course, handle 105 could be replaced by other means of actuating capacitive valve 110, automatic actuation means for example.

When capacitive valve 110 is used instead of valve V1 of FIG. 1, inlet pipe 100 is attached to tubular pipe 52, and outlet pipe 104 is connected to the airlock by tubular part 55.

When capacitive valve 110 is used instead of valve V2 of FIG. 1, inlet pipe 100 is attached to tubular part 55 to connect the airlock, and outlet pipe 104 is left free.

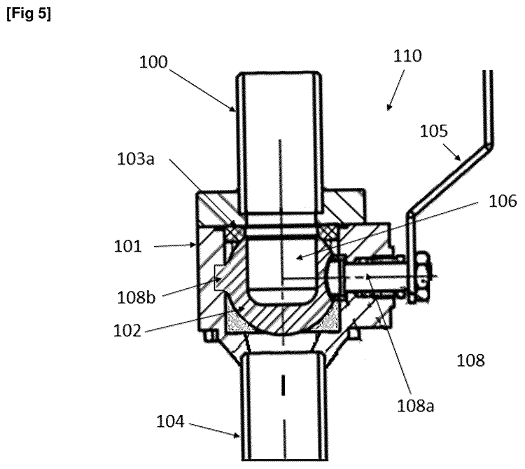

FIG. 5 schematically illustrates, by way of non-limitative example, a second type of capacitive valve 110 for the sampling device according to the invention.

This capacitive valve 110 comprises an inlet pipe 100 and an outlet pipe 104. The inlet and the outlet could of course be reversed but, for operation in gravity mode, with transfer of the solid particles by gravity, the inlet is preferably positioned above the outlet, and inlet pipe 100 and outlet pipe 104, at the connections with capacitive valve 100, are preferably on the vertical axis.

Capacitive valve 110 comprises a box 101 (also referred to as valve body) rigidly attached to inlet pipe 100 and outlet pipe 104.

Box 101 contains a ball 102 (a spherical ball here, the capacitive valve 110 shown is thus a capacitive spherical ball valve) movable (rotationally here) in box 101. Rotation of ball 102 enables operation of capacitive valve 110. This rotation is generated by operating handle 105. A shaft 108 therefore serves as a mechanical link between handle 105 and ball 102 by being rigidly attached to handle 105 and ball 102.

Preferably, shaft 108 is in pivot connection around the axis (not shown) passing through the centre of spherical ball 102. When handle 105 is actuated, shaft 108 rotates around its axis and rotationally drives the ball around this axis.

Ball 102 comprises a capacity 106 consisting of a hollow cavity (a bore here) within ball 102.

Sealing of capacitive valve 110 is provided only upstream from capacitive valve 110 (at the inlet) through contact between ball 102 and seat 103a positioned upstream from capacitive valve 110 (therefore above the ball). Unlike the capacitive valve of FIG. 3, there is no seat downstream from the ball (opposite the valve outlet).

In the position as illustrated in the figure, capacitive valve 110 is in sampling position, i.e. capacity 106 of the ball is opposite the inlet so as to enable collection of the solid particles taken through the sampling head of the sampling device, under the effect of gravity. In other words, in sampling position, capacity 106 is positioned on the upper part of ball 102 so as to collect the solid particles.

On the other hand, in discharge position, ball 102 has rotated 180° around the axis of shaft 108, capacity 106 is then in the lower part of ball 102 to discharge the solid particles under the effect of gravity. Capacity 106 is then opposite the outlet of capacitive valve 110.

This type of capacitive valve 110 with a single seat upstream preferably has a shaft 108 running through the ball to improve sealing between the seat and the ball. Shaft 108 comprises here two coaxial parts 108a and 108b positioned on either side of ball 102. Ball 102 with through shaft 108 in two parts 108a and 108b can be obtained for example by machining the ball/through shaft assembly in the mass. The ball could also be pierced so as to position the two shaft parts on either side, the other end of each shaft part being in pivot connection with box 101 to enable rotational guiding of ball 102.

Of course, handle 105 could be replaced by other means of actuating capacitive valve 110, automatic actuation means for example.

When capacitive valve 110 is used instead of valve V1 of FIG. 1, inlet pipe 100 is attached to tubular pipe 52, and outlet pipe 104 is connected to the airlock by tubular part 55.

When capacitive valve 110 is used instead of valve V2 of FIG. 1, inlet pipe 100 is attached to tubular part 55 to connect the airlock, and outlet pipe 104 is left free.

FIGS. 4 and 5 show capacitive spherical ball valves, but other types of capacitive valve may be considered without departing from the scope of the invention. For these other types of capacitive valve, the ball can be mobile in rotation like the capacitive spherical ball valves shown, or be mobile in translation or by a combination of rotation(s) and translation(s).

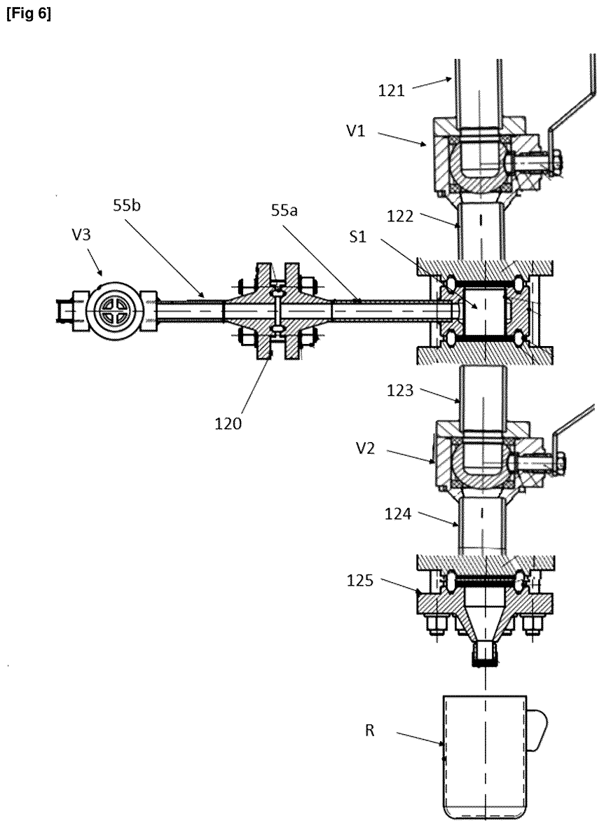

FIGS. 6 to 10 schematically show, by way of non-limitative example, various embodiments of the valve assembly at the outlet of the tubular pipe of the device according to the invention.

FIG. 6 illustrates a first embodiment of the valve assembly at the outlet of the tubular pipe.

This valve assembly comprises two capacitive valves V1 and V2, and a non-capacitive valve V3.

In this figure, inlet 121 of first capacitive valve V1 is connected to the outlet of the tubular pipe of the sampling device. In the diagram, first capacitive valve V1 is a double-seat valve identical to the valve of FIG. 4. This first capacitive valve V1 is shown in sampling position, with the capacity opposite inlet 121.

Outlet 122 of first capacitive valve V1 is attached to airlock S1.

Airlock S1 comprises two other outlets:
an outlet below airlock S1 for discharge of the solid particles by gravity. This outlet is connected to inlet 123 of second capacitive valve V2,
an outlet substantially on the horizontal axis for discharge of a fluid, notably a gas and more particularly a purge for depressurizing the fluid. This outlet is connected to a tubular part 55a to which a second tubular part 55b is attached by a flange 120. Second tubular part 55b leads to a non-capacitive valve V3 that can be connected to a flare or to a fluid collection tank.

Second capacitive valve V2 is a double-seat valve identical to the valve of FIG. 4 and identical to first capacitive valve V1. This second capacitive valve V2 is shown in sampling position, with the capacity opposite inlet 123.

Outlet 124 of second capacitive valve V2 is connected to a funnel 125 for discharging the solid particles into vessel R.

This configuration can also result from a procedure of revamping the sampling device where the initially non-capacitive valves V1 and V2 have been replaced by capacitive valves.

To recover the solid particles taken via the sampling head of the device, the valves are operated as follows:
capacitive valves V1 and V2 are positioned in sampling position (as shown in FIG. 6) and non-capacitive valve V3 is closed,
the solid particles and the fluid possibly contained in the predetermined volume taken in the sampling head flow directly into the cavity of first capacitive valve V1 by gravity,
first capacitive valve V1 is positioned in discharge position by rotating the ball 180°, second capacitive valve V2 is maintained in sampling position and non-capacitive third valve V3 is maintained closed: the solid particles then fall directly into the cavity of second capacitive valve V2,
non-capacitive third valve V3 is opened to discharge the fluid (notably gas) and/or to depressurize it, and non-capacitive third valve V3 is again closed. During this operation, second capacitive valve V2 remains in sampling position whereas the first capacitive valve can remain in discharge position (preferred case) or be repositioned in sampling position,
second capacitive valve V2 is positioned in discharge position by rotating the ball 180°: the solid particles then fall into the funnel and subsequently into vessel R where the user can recover them. During this operation, non-capacitive third valve V3 remains closed whereas the first capacitive valve can remain in discharge position (preferred case) or be repositioned in sampling position,
second capacitive valve V2 is then repositioned in sampling position, first capacitive valve V1 is repositioned in sampling position (if this operation has not been previously performed) and non-capacitive third valve V3 is maintained closed.

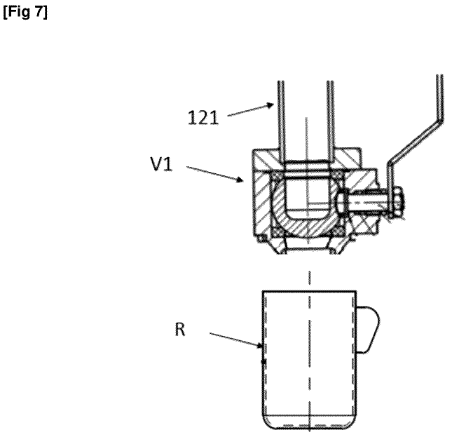

FIG. 7 illustrates a second embodiment of the valve assembly at the outlet of the tubular pipe.

This valve assembly comprises a single valve, which is a capacitive valve V1.

This configuration can be advantageously selected when the enclosure comprises only solid particles, when it comprises solid particles and a fluid at atmospheric pressure (no depressurization purge is necessary then) and, preferably, when the enclosure comprises no toxic fluid.

In this figure, inlet 121 of single capacitive valve V1, which is also the only valve of the sampling device, is connected to the outlet of the tubular pipe of the sampling device. In the diagram, single capacitive valve V1 is a double-seat valve identical to the valve of FIG. 4. This single capacitive valve V1 is shown in collection position, with the capacity opposite inlet 121.

The outlet of single capacitive valve V1 allows discharge of the solid particles directly to vessel R.

In this configuration, the sampling device comprises a single capacitive valve and no non-capacitive valve.

To collect the solid particles sampled via the sampling head of the device, the single capacitive valve is operated as follows:
the single capacitive valve V1 is positioned in sampling position (as shown in FIG. 7),
the solid particles and the fluid possibly contained in the predetermined volume taken in the sampling head directly flow into the cavity of the single capacitive valve V1 by gravity,
the single capacitive valve V1 is positioned in discharge position by rotating the ball 180°: the solid particles then fall directly into vessel R where the user can recover them,
the single capacitive valve V1 is then repositioned in sampling position.

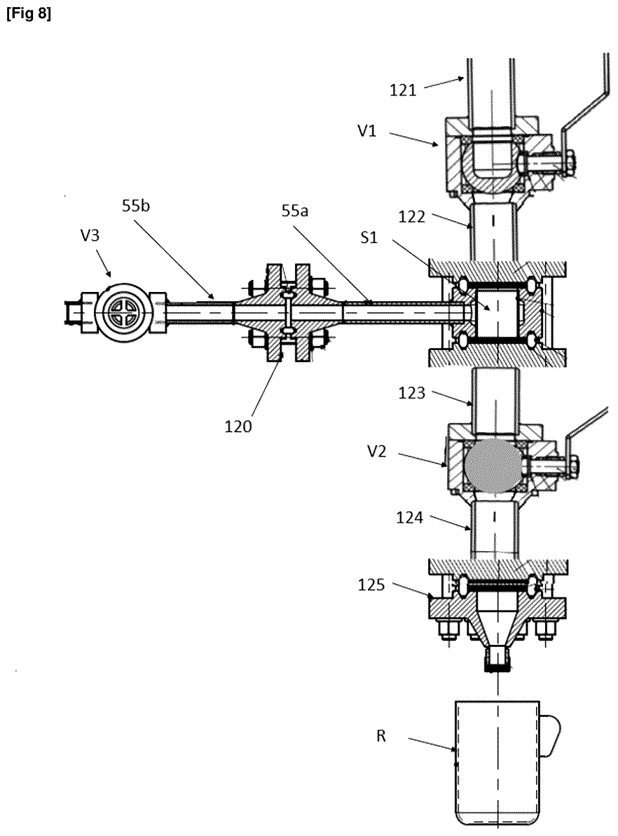

FIG. 8 illustrates a third embodiment of the valve assembly at the tubular pipe outlet.

This valve assembly comprises a capacitive valve V1 and two non-capacitive valves V2 and V3.

In this figure, inlet 121 of first capacitive valve V1 is connected to the outlet of the tubular pipe of the sampling device. In the diagram, first capacitive valve V1 is a double-seat valve identical to the valve of FIG. 4. This capacitive valve V1 is shown in collection position, with the capacity opposite inlet 121.

Outlet 122 of capacitive valve V1 is attached to airlock S1.

Airlock S1 comprises two other outlets:
an outlet below airlock S1 for discharge of the solid particles by gravity. This outlet is connected to inlet 123 of non-capacitive second valve V2,
an outlet substantially on the horizontal axis for discharge of a fluid, notably a gas and more particularly a purge for depressurizing the fluid.

This outlet is connected to a tubular part 55a to which a second tubular part 55b is attached by a flange 120. Second tubular part 55b leads to a non-capacitive valve V3 that can be connected to a flare or to a fluid collection tank.

The non-capacitive second valve V2 has a ball without an inner cavity.

Outlet 124 of non-capacitive second valve V2 is connected to a funnel 125 for discharge of the solid particles into vessel R.

This configuration can also result from a procedure of revamping the sampling device where valves V1 and V2 were initially non-capacitive valves, and where only valve V1 has been replaced by a capacitive valve.

To recover the solid particles sampled via the sampling head of the device, the valves are operated as follows:
single capacitive valve V1 is positioned in sampling position (as shown in FIG. 8) and non-capacitive valves V2 and V3 are closed,
the solid particles and the fluid possibly contained in the predetermined volume taken in the sampling head flow directly into the cavity of the single capacitive valve V1 by gravity,
single capacitive valve V1 is positioned in discharge position by rotating the ball 180°, non-capacitive second valve V2 and non-capacitive third valve V3 are maintained in closed position: the solid particles then fall directly into airlock S1 and upstream from the ball of non-capacitive second valve V2 by gravity,
non-capacitive third valve V3 is opened to discharge the fluid (notably gas) and/or to depressurize it, and non-capacitive third valve V3 is again closed. During this operation, non-capacitive second valve V2 remains closed whereas the first capacitive valve can remain in discharge position (preferred case) or be repositioned in sampling position,
non-capacitive second valve V2 is positioned in open position by rotating the ball 180°: the solid particles then flow through the ball, fall into the funnel and subsequently into vessel R where the user can recover them. During this operation, non-capacitive third valve V3 remains closed whereas the first capacitive valve can remain in discharge position (preferred case) or be repositioned in sampling position,
non-capacitive second valve V2 is closed again, first capacitive valve V1 is repositioned in sampling position (if this operation has not been previously performed) and non-capacitive third valve V3 is maintained closed.

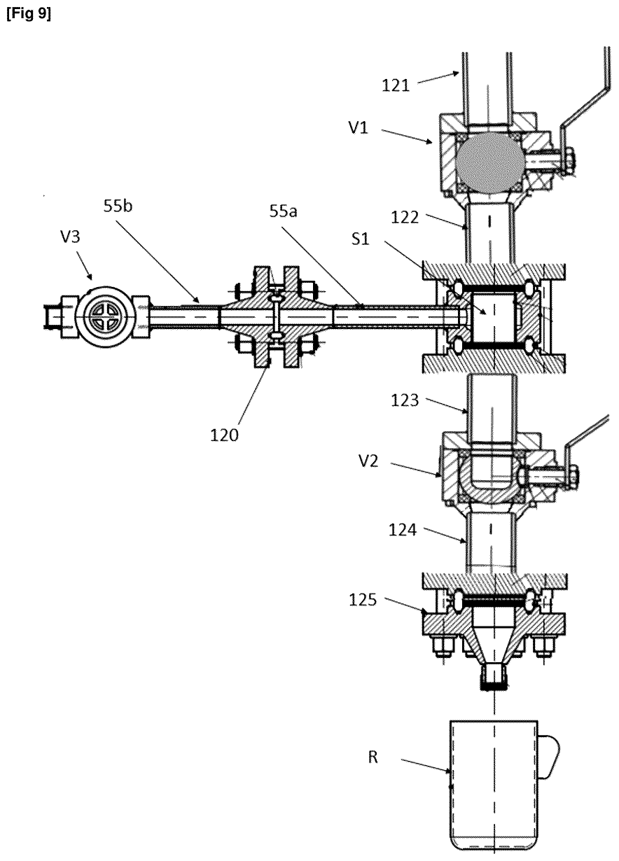

FIG. 9 illustrates a fourth embodiment of the valve assembly at the tubular pipe outlet.

This valve assembly comprises a single capacitive valve V2 and two non-capacitive valves V1 and V3.

In this figure, inlet 121 of first non-capacitive valve V1 is connected to the outlet of the tubular pipe of the sampling device. In the diagram, first non-capacitive valve V1 is a double-seat valve, but other types of non-capacitive valve could be used. This first non-capacitive valve V1 is shown in closed position.

Outlet 122 of first non-capacitive valve V1 is attached to airlock S1.

Airlock S1 comprises two other outlets:
an outlet below airlock S1 for discharge of the solid particles by gravity. This outlet is connected to inlet 123 of capacitive second valve V2,
an outlet substantially on the horizontal axis for discharge of a fluid, notably a gas and more particularly a purge for depressurizing the fluid. This outlet is connected to a tubular part 55a to which a second tubular part 55b is attached by a flange 120. Second tubular part 55b leads to a non-capacitive valve V3 that can be connected to a flare or to a fluid collection tank.

Capacitive second valve V2 is a double-seat valve identical to the valve of FIG. 4. This capacitive second valve 2 is shown in sampling position, with the capacity opposite inlet 123.

Outlet 124 of capacitive second valve V2 is connected to a funnel 125 for discharge of the solid particles into vessel R.

This configuration can also result from a procedure of revamping the sampling device where valves V1 and V2 were initially non-capacitive valves, and where only valve V2 has been replaced by a capacitive valve.

To recover the solid particles taken via the sampling head of the device, the valves are operated as follows:
single capacitive valve V2 is positioned in sampling position (as shown in FIG. 9) and non-capacitive valves V1 and V3 are closed,
the solid particles and the fluid possibly contained in the predetermined volume taken in the sampling head flow directly upstream from the ball of capacitive valve V2 by gravity,
non-capacitive first valve V1 is positioned in open position by rotating the ball, capacitive valve V2 is maintained in sampling position and non-capacitive third valve V3 is maintained closed: the solid particles then flow through non-capacitive first valve V1 and fall directly into the cavity of capacitive second valve V2,
non-capacitive first valve V1 is closed, non-capacitive third valve V3 is maintained closed and the capacitive second valve is maintained in sampling position,
non-capacitive third valve V3 is opened to discharge the fluid (notably gas) and/or to depressurize it, then non-capacitive third valve V3 is closed again. During this operation, capacitive second valve V2 remains in sampling position while non-capacitive first valve V1 remains closed,
capacitive second valve V2 is positioned in discharge position by rotating the ball 180°: the solid particles then fall into the funnel and subsequently into vessel R where the user can recover them. During this operation, non-capacitive first and third valves V1 and V3 remain closed,
capacitive second valve V2 is then repositioned in sampling position, and non-capacitive first and third valves V1 and V3 are maintained closed.

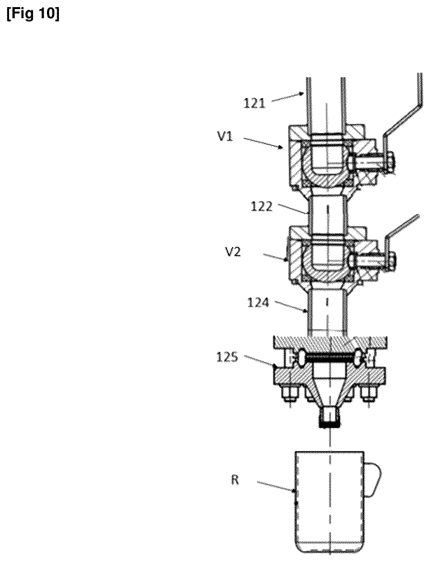

FIG. 10 illustrates a fifth embodiment of the valve assembly at the tubular pipe outlet.

This valve assembly comprises two capacitive valves V1 and V2, and it comprises neither an airlock nor a fluid discharge line.

This configuration can be advantageously implemented when the enclosure only comprises solid particles, when it comprises solid particles and a fluid at atmospheric pressure (no depressurization purge is then needed), and preferably when the enclosure comprises no toxic fluid.

In this figure, inlet 121 of first capacitive valve V1 is connected to the outlet of the tubular pipe of the sampling device. In the diagram, first capacitive valve V1 is a double-seat valve identical to the valve of FIG. 4. This first capacitive valve V1 is shown in sampling position, with the capacity opposite inlet 121.

Outlet 122 of first capacitive valve V1 is directly fastened to the inlet of second capacitive valve V2.

Second capacitive valve V2 is a double-seat valve identical to the valve of FIG. 4 and identical to first capacitive valve V1. This second capacitive valve V2 is shown in sampling position, with the capacity opposite outlet 122 of first capacitive valve V1 (which corresponds to the inlet of second capacitive valve V2).

Outlet 124 of second capacitive valve V2 is connected to a funnel 125 for discharge of the solid particles into vessel R.

In this configuration, the sampling device comprises only capacitive valves and no non-capacitive valve.

To recover the solid particles sampled via the sampling head of the device, the valves are operated as follows:
capacitive valves V1 and V2 are positioned in sampling position (as shown in FIG. 10),
the solid particles and the fluid possibly contained in the predetermined volume taken in the sampling head flow directly into the cavity of first capacitive valve V1 by gravity,
first capacitive valve V1 is positioned in discharge position by rotating the ball 180°, and second capacitive valve V2 is maintained in sampling position: the solid particles then fall directly into the cavity of second capacitive valve V2,
second capacitive valve V2 is positioned in discharge position by rotating the ball 180°: the solid particles then fall into the funnel and subsequently into vessel R where the user can recover them. During this operation, first capacitive valve V1 can remain in discharge position (preferred case) or be repositioned in sampling position,
second capacitive valve V2 is then repositioned in sampling position, and first capacitive valve V1 is repositioned in sampling position (if this operation has not been previously performed).

In FIGS. 6 to 10, the capacitive valves are shown as capacitive spherical ball valves, but other types of capacitive valve could be used instead of capacitive spherical ball valves without departing from the scope of the invention.

1. A device (10) for sampling solid particles (14) from a sealed enclosure (12), sampling device (10) comprising a tubular body (18) carrying a sampling head (16), sampling head (16) being configured for gravity sampling of a predetermined volume of solid particles (14) from said sealed enclosure (12), sampling device (10) comprising a tubular pipe (52) attached to tubular body (18) and forming a non-zero angle with tubular body (18), tubular body (18) comprising a deflector (50) for deflecting solid particles (14) in tubular pipe (52), characterized in that sampling device (10) comprises a first capacitive valve for discharging the solid particles, positioned downstream from tubular pipe (52), in the direction of flow of solid particles (14) in sampling device (10).

2. A device (10) for sampling solid particles (14) from a sealed enclosure (12) as claimed in claim 1, wherein the volume of the capacity (106) of the first capacitive valve is greater than said predetermined volume, the volume of capacity (106) of the first capacitive valve is preferably at least 1.05 times, and more preferably at least 1.15 times said predetermined volume.

3. A device (10) for sampling solid particles (14) from a sealed enclosure (12) as claimed in claim 1, wherein the first capacitive valve comprises a single seat (103a) and a capacitive ball (102), single seat (103a) being upstream from capacitive ball (102).

4. A device (10) for sampling solid particles (14) from a sealed enclosure (12) as claimed in claim 1, wherein the first capacitive valve comprises a first seat (103a), a second seat (103b) and a capacitive ball (102), first seat (103a) being upstream from capacitive ball (102) and second seat (103b) being downstream from capacitive ball (102).

5. A device (10) for sampling solid particles (14) from a sealed enclosure (12) as claimed in claim 1, wherein the first capacitive valve is selected from among capacitive spherical valves, capacitive conical ball valves or capacitive cylindrical ball valves.

6. A device (10) for sampling solid particles (14) from a sealed enclosure (12) as claimed in claim 1, wherein sampling device (10) comprises a second valve downstream from tubular pipe (52) for discharge of solid particles (14), the second valve being upstream or downstream from the first capacitive valve, the first capacitive valve and the second valve being connected to one another directly or by means of an airlock (S1).

7. A device (10) for sampling solid particles (14) from a sealed enclosure (12) as claimed in claim 6, wherein sampling device (10) comprises an interlock key system for preventing simultaneous operation of the first capacitive valve and of the second valve.

8. A device (10) for sampling solid particles (14) from a sealed enclosure (12) as claimed in claim 6, wherein airlock (S1) is connected to a third valve (V3) for discharging a fluid, the fluid being contained in the predetermined volume.

9. A device (10) for sampling solid particles (14) from a sealed enclosure (12) as claimed in claim 6, wherein the second valve is a second capacitive valve, the first capacitive valve and the second capacitive valve being preferably identical.

10. A system including a sealed enclosure (12) comprising solid particles (14), and a device (10) for sampling solid particles (14) as claimed in claim 1, the system being intended for one of the applications as follows: catalyst sampling in a petroleum refining unit, in a gas or biomass treating plant, in a renewable fuel production unit, in a reforming unit, in a Fischer-Tropsch unit or in a unit for dehydrating alcohol to olefin.

11. A method for sampling solid particles (14) from a sealed enclosure (12) using a sampling device (10) as claimed in claim 1, wherein at least the following steps are carried out:
taking a predetermined volume comprising solid particles (14) from sealed enclosure (12) through sampling head (16),
sending the predetermined volume taken to capacity (102) of the first capacitive valve in sampling position,
actuating the first capacitive valve to discharge the predetermined volume comprising solid particles (14) of the first capacitive valve, and repositioning the first capacitive valve into sampling position once the predetermined volume discharged.

12. A method for sampling solid particles (14) from a sealed enclosure (12) using a sampling device (10) as claimed in claim 8, the first capacitive valve being positioned upstream from the second capacitive valve, wherein at least the following steps are carried out:
taking a predetermined volume comprising solid particles (14) from sealed enclosure (12) through sampling head (16),
sending the predetermined volume taken to capacity (102) of the first capacitive valve in sampling position,
actuating the first capacitive valve to discharge the predetermined volume to airlock (S1) or directly to the second capacitive valve in sampling position, and once the predetermined volume discharged, repositioning the first capacitive valve into sampling position,
when the predetermined volume is discharged to airlock (S1), preferably discharging a fluid contained in the predetermined volume through third valve (V3) that is opened and subsequently closed once the fluid discharged,
actuating the second capacitive valve to discharge solid particles (14) contained in the predetermined volume into a vessel (R), and once solid particles (14) discharged, repositioning the second capacitive valve into sampling position.

13. A method of revamping a device (10) for sampling solid particles (14) from a sealed enclosure (12), sampling device (10) comprising a tubular body (18) carrying a sampling head (16), sampling head (16) being configured for gravity sampling of a predetermined volume of solid particles (14) from said sealed enclosure (12), sampling device (10) comprising a tubular pipe (52) attached to tubular body (18) and forming a non-zero angle with tubular body (18), tubular body (18) comprising a deflector (50) for deflecting solid particles (14) in tubular pipe (52), sampling device (10) comprising at least one valve downstream from tubular pipe (52), the method comprising a step wherein the at least one valve downstream from tubular pipe (52) is replaced by a capacitive valve (110) so as to obtain a sampling device (10) as claimed in claim 1.
